(19) United States
(12) Patent Application Publication
(10) Pub. No.: US 2026/0002363 A1
(43) Pub. Date: Jan. 1, 2026

(54) MODULAR ROOF STRUCTURE

(71) Applicant: William BEAUMONT, Braemar (AU)

(72) Inventor: William BEAUMONT, Braemar (AU)

(21) Appl. No.: 19/111,924

(22) PCT Filed: Sep. 14, 2023
(86) PCT No.: PCT/AU2023/050885

§ 371 Date: Mar. 14, 2025

(30) Foreign Application Priority Data
Sep. 14, 2022 (AU) 2022902658

(51) Int. Cl. E04D 13/04; E04D 3/40; H02S 20/23; H02S 30/10

(52) U.S. Cl. CPC E04D 13/0445; E04D 3/40; H02S 20/23; H02S 30/10

(57) ABSTRACT

A modular roof structure comprises a frame to which an array of solar panels are attachable. The frame comprises purlins at a periphery of the roof structure, the purlins being configured to receive edges of the solar panels thereat, and rafters arranged between the purlins in a configuration to receive opposing edges of adjacent solar panels thereat, the rafters comprising gutters for collecting water that runs off the solar panels and directing the collected water to a water outlet.

### TECHNICAL FIELD

The present invention relates to modular roof structures that incorporate solar panels.

### BACKGROUND ART

Commercial solar power installations have reportedly doubled in the last two years, due to factors such as falling costs of solar panels and corporations' increasingly ambitious ESG commitments. The majority of solar installations are rooftop installations, which can be problematic because many sites have limited suitable rooftop space and can therefore only use solar installations that generate a fraction of their onsite electricity requirements.

Solar shade structures, such as solar carport installations, are one solution to this problem. Not only can solar carports increase the solar capacity of a premises, they can also provide benefits such as shading, weather protection and lighting. Uptake has, however, been impeded by factors such as the cost of solar carport installations (estimated to be up to 3× higher than for rooftop solar installations), labour intensity, slow install time and poor aesthetics of available structures. In particular, site labour is expensive (40% of the turnkey cost is estimated to be labour costs), difficult to schedule and susceptible to significant variance in quality, competency and overall speed. Further, the majority of installations are retrofitted to existing carparks and thus have strict installation windows to minimise carpark disruptions.

Furthermore, conventional shade structures used in car parks (and elsewhere) are constructed using relatively cheap membrane-based materials and, even taking into account factors such as electricity savings from the electricity generated from the solar panels, solar shade structures are currently not commercially competitive. Indeed, a cost-analysis performed by the inventor indicates that existing solar shade structures are more than double the cost of membrane based shade structures.

Factors such as those described above have limited the widespread adoption of solar shade structures, including as solar carport installations.

### SUMMARY OF INVENTION

In a first aspect, the present invention provides a modular roof structure comprising a frame to which an array of solar panels are attachable. The frame comprises purlins at a periphery of the roof structure, the purlins being configured to receive edges of the solar panels thereat, and rafters arranged between the purlins in a configuration to receive opposing edges of adjacent solar panels thereat, the rafters comprising gutters for collecting water that runs off the solar panels and directing the collected water to a water outlet.

In a second aspect, the present invention provides a modular roof structure comprising a frame to which an array of solar panels that define an upper surface of the roof structure are attached. The frame comprises purlins at a periphery of the roof structure, the purlins being configured to receive edges of the solar panels thereat, and rafters arranged between the purlins in a configuration to receive opposing edges of adjacent solar panels thereat, the rafters comprising gutters for collecting water that runs off the solar panels and directing the collected water to a water outlet.

Advantageously, the modular nature of the present invention drastically reduces the amount of time required to install a shade structure, resulting in a significantly lower associated labour cost. The modular roof structure of the present invention is also readily transportable and substantially waterproof. Indeed, the inventor has found that the modular roof structure described in further detail below was around four times faster to install on-site than other structures, whilst having a similar material cost. By incorporating pre-fabrication in the structure's base design, most of the assembly can be completed under controlled factory conditions using repeatable processes. Furthermore, as factory labour is usually cheaper than site labour, the overall cost is even further reduced.

As noted above, existing systems manufacture solar shade structures on site, which is labour intensive because most of the work needs to be completed using a scissor lift, with a high level of manual material handling at an awkward working height for installers on-site. Compliance with WH&S requirements and other site limitations can greatly complicate the installation of such roofing.

The advantages described above result in the modular roof structures of the present invention having an installation cost that is closer to that of the conventional membrane based shade structures described above. Given that solar shade structures have physical advantages over membrane based shade structures, in that solar panels currently have a design life of 30 years (vs 10-15 years for shade structure membrane), can incorporate lighting and electric vehicle charging infrastructure (e.g. via ‘piggy backing’ off existing electrical infrastructure required for the base build of the solar shade structure) and have better aesthetic outcomes, it is believed that the present invention provides a commercially viable alternative to the industry norm.

The modular roof structure of the present invention is also inherently waterproof, something that is, at best, an expensive addition to existing systems (e.g. some solar structures achieve waterproofing using an internal sheet roof underneath the solar panels). In the embodiments described in further detail below, for example, the modular roof structure uses a steel guttering system that is inexpensive to produce and is dimensionally very accurate, as it is laser cut and requires no gaskets, making it less prone to degradation and hence the attendant loss of waterproofing effectiveness over time.

In some embodiments, the purlins may define the entire periphery of the roof structure, such a configuration imparting a high degree of strength and structural stability to the modular roof structure.

In some embodiments, the rafters may be laterally and longitudinally arranged (i.e. with respect to the purlins) to correspond with the size of the solar panels. The lateral gutters may, for example, be vertically spaced from the longitudinal gutters, such that the collected water flows from one into the other.

In some embodiments, the collected water may be directed by the gutters to a common water outlet. Such an outlet may facilitate easier plumbing during the on-site installation.

In some embodiments, the solar panels may be attached to the frame via attachments that are accessible from underneath the frame. Advantageously, this enables the panels to be removed and replaced from underneath the roof structure, a far more easily accessible place than above the roof structure. Solar panels in existing roof structures are attached to the roof via clamps, brackets, or the like, that are accessed from the upper surface. However, solar panels are not weight bearing and accessing such panels requires the use of specialised equipment such as scissor lifts or cranes. Further, individual panels usually cannot be accessed without having to remove multiple other panels beforehand.

In some embodiments, the gutters may comprise outwardly extending flanges at an upper portion thereof. Such flanges may comprise attachments for the solar panels and, in some embodiments, the attachments may comprise apertures that are alignable with apertures in the undersides of frames of the solar panels, and through which a fastener such as a nut and bolt may be passed. Directly connecting the panels to the gutters reduces the number of component parts and hence further simplifies the system.

In some embodiments, the rafters and/or purlins may be closed section beams. Such a configuration is strong and also enables electrical wiring to be located within voids inside the rafters/purlins, which allows for internal cable reticulation, no visible screw lines and an easily transportable structure.

In embodiments of the present invention, the modular roof structure may be pre-wired, waterproofed and provided in the form of discrete modular ‘pods’ that are self-supported by the purlins. These pods may have 2 solar panels in landscape and be 3 or 4 solar panels long, or 3 panels in landscape by 3-4 panels long. The pods mechanically protect the panels and can be easily transported by a flatbed truck from the factory to site, as described in further detail below.

In a third aspect, the present invention provides a method for constructing a structure in which an array of solar panels define an upper surface thereof. The method comprises:
affixing one or more upright supports to the ground;
positioning one or more of the modular roof structures of the first or second aspect of the present invention on top of the one or more upright supports; and
attaching the one or more modular roof structures to the one or more upright supports.

In some embodiments, the method may further comprise electrically connecting the solar panels to an electricity grid.

The structure may, for example, be a shade for a car park or a garage, a covered outdoor learning area (COLA) at schools, cattle yard roofs and awnings. The structure may be used as a replacement for shed or factory roofs. It may also be used in agricultural applications such as glasshouses and as shade for crops that are sensitive to excessive sunlight or heat.

Additional features and advantages of the various aspects of the present invention will be described below in the context of specific embodiments. It is to be appreciated, however, that such additional features may have a more general applicability in the present invention than that described in the context of these specific embodiments.

### BRIEF DESCRIPTION OF DRAWINGS

Embodiments of the present invention will be described in further detail below with reference to the following drawings, in which:

FIG. 1 shows a modular roof structure in accordance with an embodiment of the present invention, having a 2×4 array of solar panels;

FIG. 2 shows a modular roof structure in accordance with another embodiment of the present invention, having a 3×4 array of solar panels;

FIG. 3 shows a top view of a modular roof structure in accordance with another embodiment of the present invention, configured to receive a 2×4 array of solar panels;

FIG. 4 shows a sectional view along the line A-A of the modular roof structure of FIG. 3;

FIG. 5 shows an enlarged view of the central rafter shown in FIG. 4;

FIG. 6 shows a partial cross sectional view along the line B-B of the modular roof structure of FIG. 3;

FIG. 7 shows a cross sectional view of a rafter and gutter of a modular roof structure in accordance with another embodiment of the present invention;

FIG. 8 shows a plurality of modular roof structures in accordance with an embodiment of the present invention stacked on a truck for transport to a site;

FIG. 9 shows two upright supports fixed to the ground, upon which the modular roof structures depicted in FIG. 8 are to be installed;

FIG. 10 depicts the installation of three of the modular roof structures depicted in FIG. 8 onto the two upright supports shown in FIG. 9;

FIGS. 11A, 11B and 11C depict an adjustable cleat system for use with the upright supports shown in FIG. 9;

FIG. 12 depicts a situation when, during installation, the length of the modules will not evenly divide into the span of two upright supports; and

FIG. 13 depicts the installation of individual solar panels onto the overlap depicted in FIG. 12.

### DESCRIPTION OF EMBODIMENTS

As noted above, in one aspect the invention provides a modular roof structure comprising a frame to which an array of solar panels are attachable and, in another aspect, a modular roof structure comprising a frame to which an array of solar panels that define an upper surface of the roof structure are attached. In both aspects, the frame comprises purlins at a periphery of the roof structure, the purlins being configured to receive edges of the solar panels thereat, and rafters arranged between the purlins in a configuration to receive opposing edges of adjacent solar panels thereat, the rafters comprising gutters for collecting water that runs off the solar panels and directing the collected water to a water outlet.

The modular roof structure of the present invention will be descried below primarily in the context of shade structures in commercial outdoor car parks. It will be appreciated, however, that applications for the present invention are far more extensive than this. For example, the modular roof structure may be used in covered outdoor learning areas (COLAs) at schools, in cattle yard roofs and in building awnings. The structure may also be used as a replacement for garages, sheds or factory roofs, as well as in agricultural applications such as glasshouses and as shade for crops that are sensitive to excessive sunlight or heat.

In shade structures in commercial car parks, the modular roof structure of the present invention can replace existing membrane-based shade structures, which are usually made from a UV stabilised polyurethane cloth. Companies are increasingly looking to utilise solar shade structures that have the benefits of onsite renewable energy generation, longer lifespans than shade cloth (which is usually not waterproof and prone to damage from winds and the sun) and able to be integrated with emerging technologies such as electric vehicle charging stations. Existing solar shade structures have had a relatively poor uptake due to their high cost and slow installation time (which is very disruptive to live carparks) and are therefore not a commercially viable option for most carparks. However, as the modular nature of the present invention significantly lowers both the price point and installation time of a solar shade structure, it presents a commercially compelling alternative to existing shade structures (including cloth shade structures).

Advantageously, the configuration of the modular roof structure of the present invention provides a substantially waterproof structure. The inventor notes that designing a modular system that is waterproof represented a significant challenge and that most carport suppliers do not have a waterproof solution, short of installing a steel roof underneath the entire array. Although existing solar car park shade structures (and, indeed, more conventional shade structures) are usually not waterproof, it is likely that as the industry matures there will be increasing demand for a system that can provide both shade and rain shelter in carparks. The inventor also notes the inherent benefits of keeping water separate from electrical components of a solar panel.

The rafters and purlins in the modular roof structure of the present invention may have any suitable configuration that is compatible with the invention's utility. The purlins may, for example define all or a portion of the periphery of the roof structure. The rafters may, for example, be laterally and longitudinally arranged to correspond with the size of the solar panels, whereupon lateral and longitudinal edges of the solar panels are in alignment with the rafters, thus even more readily facilitating their attachment.

The rafters include gutters for collecting water running off the solar panels and directing the collected water to a water outlet (either a common water outlet or a plurality of water outlets). The configuration of the gutters and rafters may take any suitable form, and the gutters may be integral to the rafters or affixed to the rafters. In some embodiments, for example, the gutter may be located above a structural beam of the rafter and underneath the solar panels. In some embodiments, the gutters may provide for additional functionality. For example, in some embodiments, the gutters may comprise outwardly extending flanges at an upper portion thereof. The flanges may comprise attachments for the solar panels. The attachments may, for example, be apertures that are alignable with apertures in the undersides of frames of the solar panels.

Additional components may be provided with the rafters in order to enhance their functionality, in the context of the present invention. For example, flashing may be provided between the solar panel and the gutter in order to prevent any water from seeping between edges of the panel and other components (i.e. such that it would not fall into the gutter).

In some embodiments, lateral gutters in the modular roof structure may be vertically spaced from longitudinal gutters, whereby the collected water flows from one into the other. Spacers between the rafter and the gutter, such as those described below, may, for example, be used to provide this effect. Such embodiments may allow for a simpler construction, whilst still providing for a waterproof structure.

The solar panels may be attached to the frame using any suitable configuration of attachments. In some embodiments, the solar panels may be attached to the frame via attachments that are accessible from underneath the frame. As noted above, being able to attach and detach the solar panels from the frame from underneath the roof structure (particularly after the structure has been installed) is a far easier task than doing so from above, as is necessitated by the majority of conventional solar panel brackets that utilise a clamp over the aluminium frame of the panel to hold it in place (primarily because the panels have been adapted from on-roof applications, where access from underneath is simply not possible).

In some embodiments, for example, a bracket may be provided that attaches to the pre-drilled holes in the back of the panel's frame (these holes are often used for single axis tracking and dual axis tracking ground mount applications). This provides additional advantages for waterproofing, as well as module maintenance, as there is a continuous gap between the modules with no obstructions from clamps and the panel can be accessed and removed from the underside. There are also no requirements for aluminium rail or additional structural supports, as the brackets can be attached directly onto the purlins/rafters.

In some embodiments, the rafters and/or purlins may be closed section beams. Closed section beams have a number of advantageous properties, including the ability for electrical cables to be routed within in the void of the beam, meaning that there is no requirement for additional mechanical protection or zip ties, and that screws and other attachments face into the void of the beam, resulting in there being no sharp edges or areas for dust, birds, or people to grab onto. Closed section beams are also structurally stronger than open section beams, and generally do not require cross bracing to prevent deflections in the vertical and horizontal planes. The closed section purlin used in the structures described below is commercially available as Boxspan® Purlin, from Spantec Systems Pty Limited, and has a lightweight steel profile.

The modular roof structure of the present invention may have any shape, with a rectangular shape being preferred in the context of carports. Rectangular shapes are also best for accommodating solar panels which are themselves typically rectangular in shape. The modular roof structure may have any suitable size, with arrays of solar panels two panels wide and four panels long being found to strike a good balance between size, weight and portability, particularly in the context of carports.

In some embodiments, the modular roof structure may also include additional guttering on at least the lowermost, in use, purlin. Such guttering would catch any water flowing off the lowermost edges of the panels on the structure, and direct it to the water outlet(s).

The present invention also provides a method for constructing a structure in which an array of solar panels define an upper surface thereof. The method comprises:
affixing one or more upright supports to the ground;
positioning one or more of the modular roof structures of the present invention, as described herein, on top of the one or more upright supports; and
attaching the one or more modular roof structures to the one or more upright supports.

In some embodiments, the method may further comprise electrically connecting the solar panels to an electricity grid. Any conventional technique, carried out by a suitably qualified electrician, can be used to achieve this.

In some embodiments, the supports may be configured with components that can even further simplify installation of the modular roof structures. For example, components such as the adjustable cleat and sliding plate described below reduce the level of accuracy required to position the modular roof structures on the upright supports during installation.

Specific embodiments of the structure and methods of the present invention will now be described with reference to Figures.

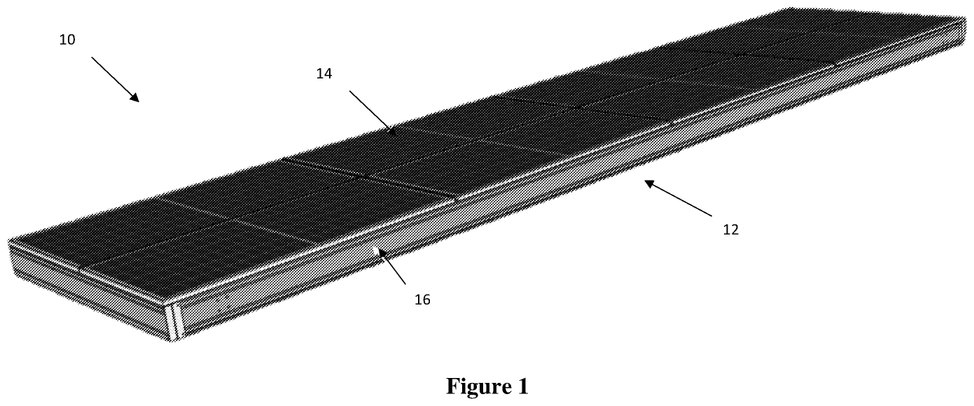

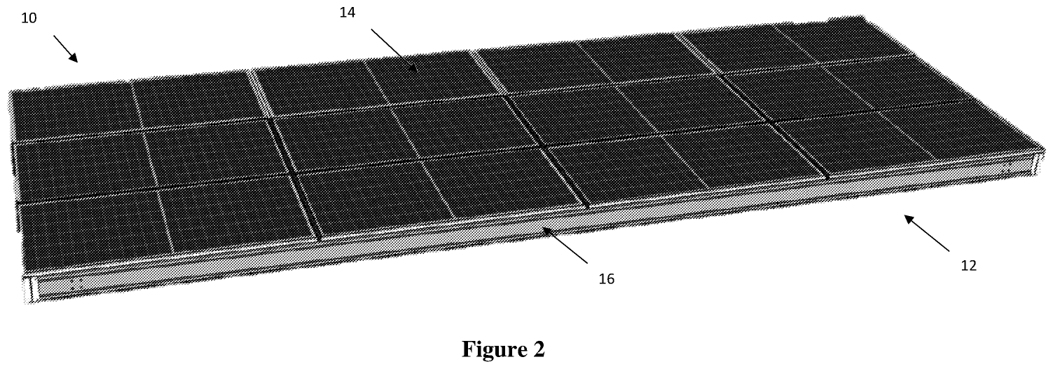

FIGS. 1 and 2 depict modular roof structures in accordance with embodiments of the present invention in the form of a solar pod 10. The solar pod 10 includes an array of solar panels, shown generally as solar panels 14, mounted on a frame 12 which includes purlins 16 around its periphery and rafters 18 (not shown in FIGS. 1 and 2). Solar pod 10 also incorporates wiring and module fixing and waterproofing components (as described below). Solar pods 10 are manufactured in a factory to exacting specifications and are easily transportable (e.g. up to twenty pods can be stacked on top of each other on a truck, which would cover sixty carparks), where they are fast to install on-site with either a forklift or mobile crane (as described below). Compared to the conventional solar shade structures, such as those described above, approximately 80% of the site works can be carried out in the factory, resulting in the site installation being faster and more reproduceable, with the overall cost being significantly cheaper.

In FIG. 1, a pod 10 having a 2×4 configuration of solar panels 14 (2 m×8 m) is shown, which is capable of generating 3.6 kWp of solar power (assuming 450 W modules). Such a pod would be suitable for use in small to medium commercial installations (up to ˜150 kWp). This size of pod can be easily transported on a standard flatbed truck, with a stack height of 11 pods (<4.3 m total height) approximately 40 kWp of pods can be transported per truck.

In FIG. 2, a pod 10 having a 3×4 configuration of panels 14 (resulting in a pod size of 3 m×8 m) is shown, which is capable of generating 5.4 kWp of solar power (assuming 450 W modules). Such a pod would be suitable for use in larger commercial installations (+150 kWp). This structure would need to be transported on an oversize truck as the width is greater than 2.5 m, however as it is under 3.5 m in width the truck only requires special signage and lighting to transport which results in only a minor increase in transport costs. With a stack height of 11 pods (<4.3 m total height) approximately 57 kWp of pods can be transported per truck.

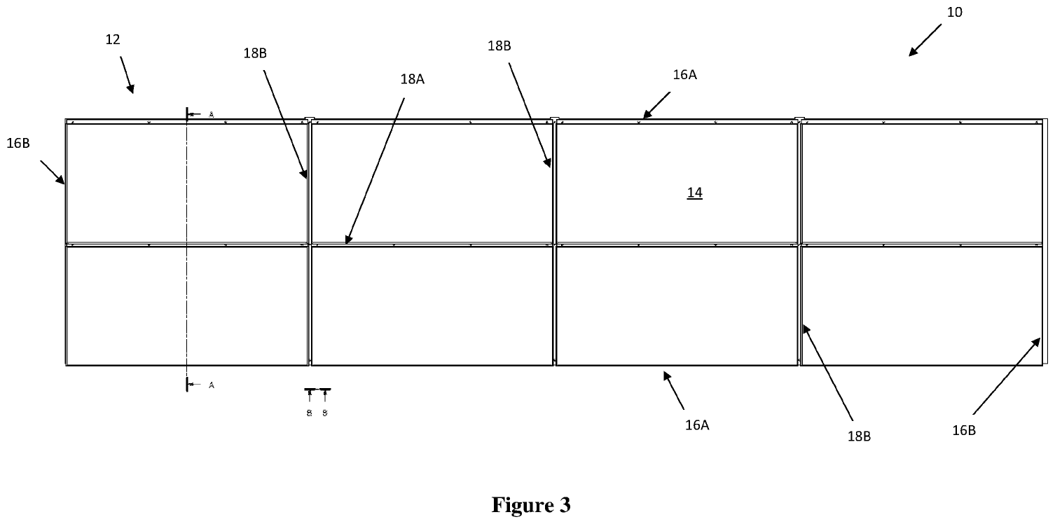

Referring now to FIGS. 3 to 6, depicted is a modular roof structure in accordance with embodiments of the present invention, again in the form of solar pod 10. Pod 10 includes an array of solar panels (a 2×4 array in this embodiment), shown generally as solar panel 14, on an uppermost side and attached to a frame 12. Frame 12 is rectangular in shape and includes purlins, in the form of longitudinal purlins 16A, 16A and lateral purlins 16B, 16B, around its entire periphery. Purlins 16 are provided in the form of commercially available Boxspan® Purlins, as described above. A central longitudinal rafter 18A is provided intermediate the longitudinal purlins 16A and 16A, and three lateral rafters 18B, 18B and 18B are equispaced along the length of the frame 12. Rafters 18A and 18B are positioned such that adjacent edges of opposing panels 14 are positioned thereabove and for affixing thereto, in the manner described below.

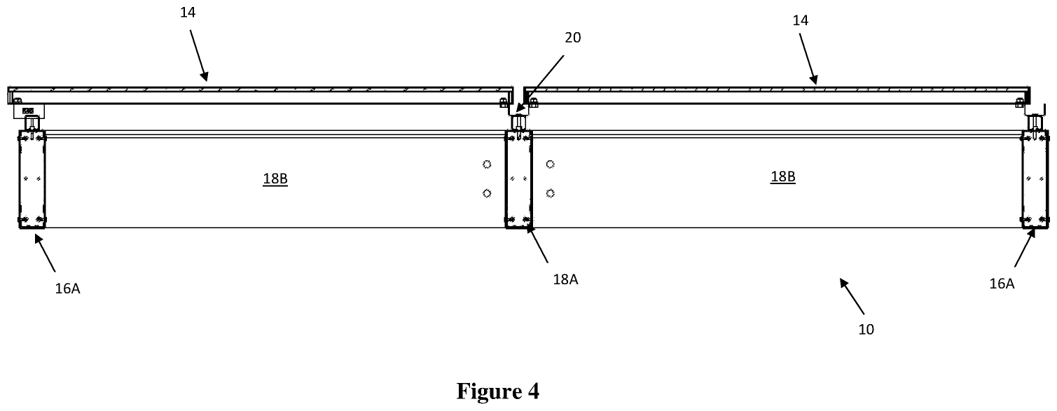

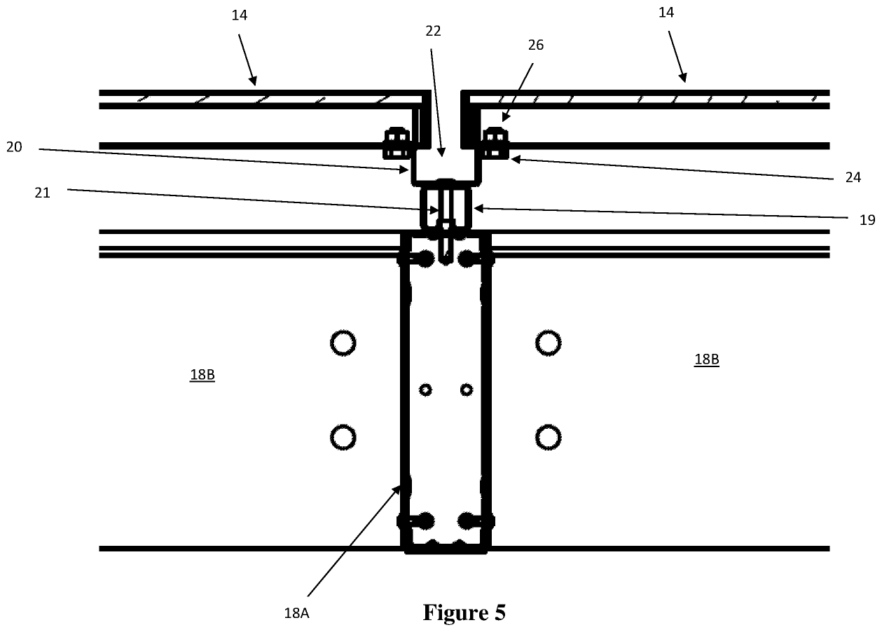

As can most clearly be seen in FIGS. 4 and 5, a longitudinal gutter 20 is positioned above rafter 18A. Gutter 20 includes a channel 22 that directs a flow of water therealong, and which is defined by upright edges and flanges 24 on one or both sides thereof. Flange 24 provides a surface into which apertures (not shown) can be provided for alignment with apertures (also not shown) provided on the underside of solar panels 14 for a fastener 26 to be passed therethrough. In such a manner, panels 14 can be affixed to the rafter 18A (and hence to frame 12) via the gutter 20. A second, adjacent panel 14 can be attached to the opposing flange 24 of the gutter 20 in a similar manner, with the edges of the panels 14, 14 overlying the gutter. In this manner, rain which falls onto the uppermost of the two panels 14 will, in use, be directed into channel 22 and hence to a water outlet (not shown). As can be seen, gutter 20 is spaced apart from rafter 18A by a square hollow section member 19, which results in the vertical offset of gutter 20 and a lateral gutter 28 described below. A fastener 21 (e.g. a tek screw) joins the three components. Longitudinal gutter 20 is broken along its length in order to allow water to flow into lateral gutters 28, as will be described below. As will be appreciated, in alternative embodiments, gutter 20 may be provided as a single part, with holes adapted to align with gutters 28 provided in channel 22.

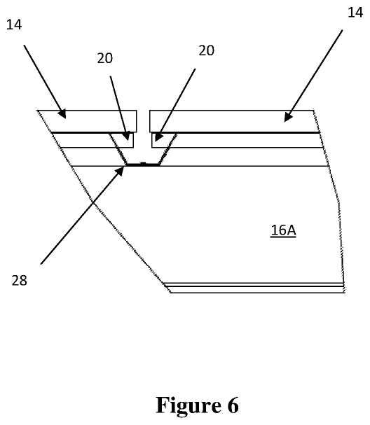

Referring now to FIG. 6, the lateral gutter 28 is shown positioned on top of lateral rafter 18B (which can't be seen in this view) and purlin 16A. Lateral gutter 28 is positioned to receive water flowing out of adjacent longitudinal gutters 20, 20 such that any rainwater which enters the gutters 20, 20 flows into gutter 28 and is directed to a water outlet (not shown). In the embodiment shown, the lateral gutter 28 is located vertically below the longitudinal gutters 20, 20 such that rainwater overflows from gutter 20 into gutter 28. Lateral gutters 28 extend across the width of pod 10 and, due to the angle of the pot once installed (discussed below), provide an appropriate fall for draining the water. An external gutter (not shown) along the lowermost edge of the pod 10 may collect water flowing from lateral gutters 28, 28 and 28 (located on top of rafters 18A, 18B and 18C), and direct it to a downpipe (also not shown) and hence into stormwater.

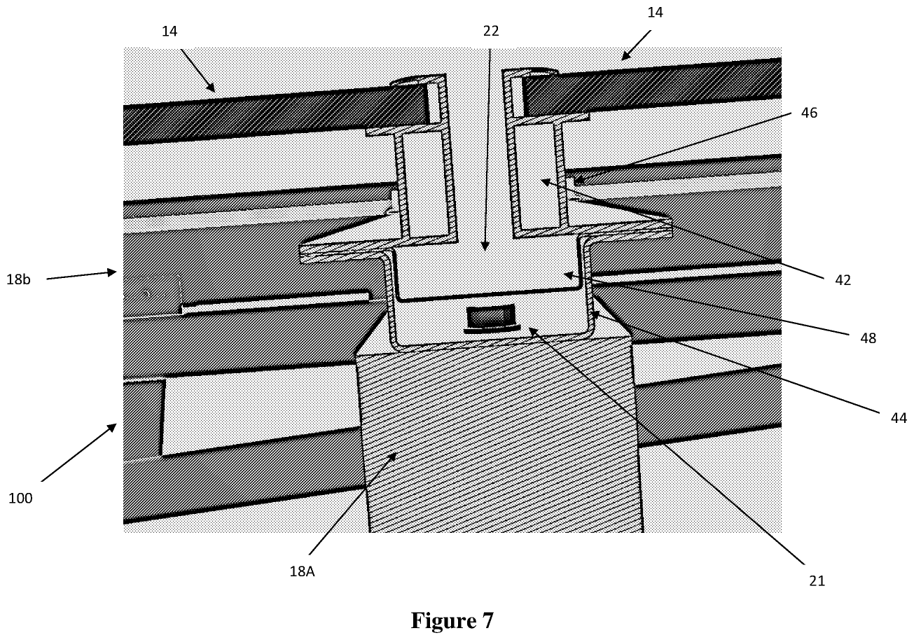

Referring now to FIG. 7, shown is a cross sectional view of a longitudinal rafter 18A and gutter 44 of a pod 10 in accordance with another embodiment of the present invention. In this embodiment, adjacent solar panels 14, 14 are affixed to the pod 10 via brackets 42, 42, which have an upper portion configured to receive and retain an edge of the panel 14 and a lower portion including a flange which has apertures configured to align with apertures on flanges of the gutter 44, similar to that described above with reference to FIG. 5. Self-clinching studs 46 may be used to hold the components together.

Gutter 44 is again affixed to rafter 18A with a tek screw 21 although, in this embodiment, a spacer (e.g. spacer 19) is not required. Instead, a channel 22 is defined by a U-shaped member 48 having a shallower profile than gutter 44, and which snugly fits within gutter such that its flanges are sandwiched between the bracket 42 and gutter 44 flanges. In this embodiment, longitudinal channels 22 are vertically offset from the lateral gutters 28 by the raised floor of the channel 22 provided by member 48.

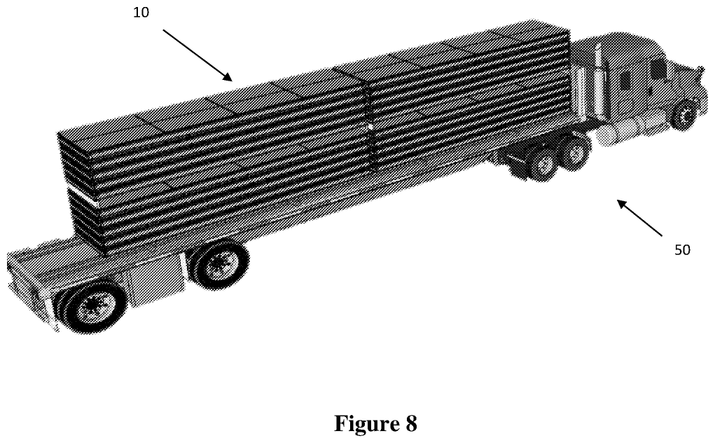

Referring now to FIG. 8, shown is a truck 50, on which pods 10 in packs of at most 5, stacked 2 packs high, are loaded. The maximum number of such pods per truck is therefore 20, which corresponds to approximately 60 kWp and 90 kWp installed capacity in two and three pod wide configurations respectively.

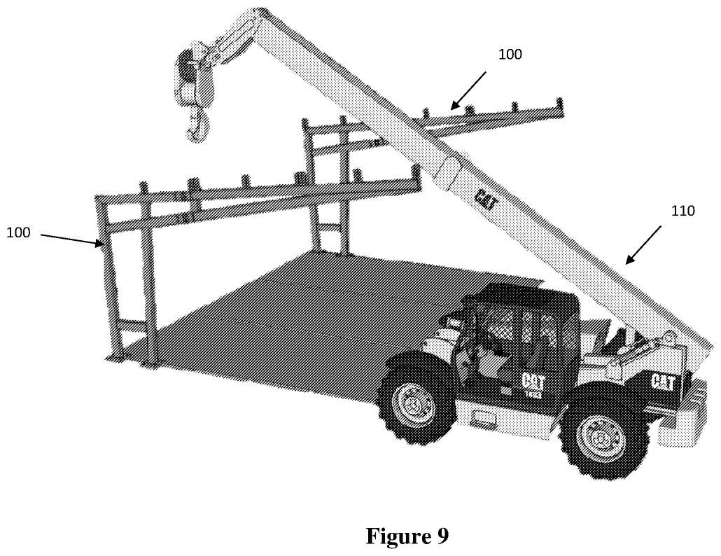

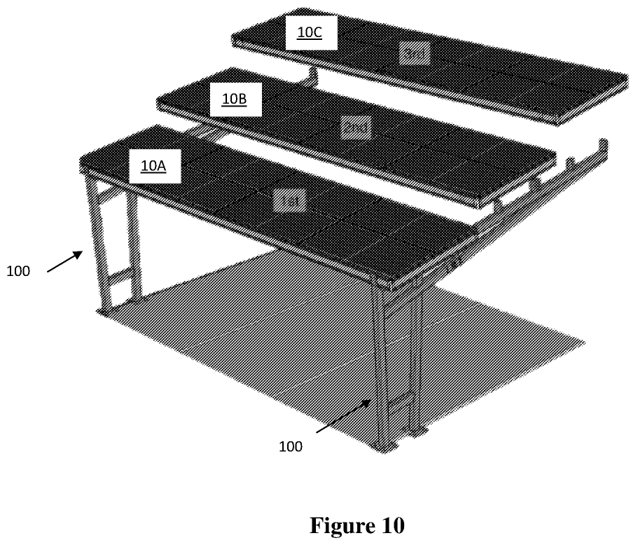

The installation of the prefabricated solar system can be broken into three basic steps and is depicted in FIGS. 9 and 10. Briefly, in a first step, the uprights 100, 100 are erected at an appropriate spacing. Once uprights 100, 100 are securely affixed to the ground, the pods 10 are installed onto the uprights 100, 100 as described below. Any overlapping module installation (described below) is then carried out before the final wiring takes place.

In the first step, foundations are marked out to minimise obstruction to the carpark. The most common layout in a standard carpark (carpark space 2.5 m wide×5.6 m long) is to span three carparks (i.e. 7.5 m wide). The foundations are then installed. Depending on carpark type and geotechnical results, the foundations may be constructed from excavated concrete pile (most common), bolted plate connection (e.g. used on multi-level carpark), chem-set anchor into existing concrete slab or using a Surefoot micro pile system. The columns 100 are then erected, which may be achieved by lifting into place with soft straps and vertical lift equipment such as a telehandler 110, forklift or spider crane (not shown).

The pods 10A, 10B and 10C may be lifted into place by either a telehandler with overhead lifting attachment 110 or using a forklift. They will then be bolted into place using the cleats on the structure to fix through pre-drilled fixing holes in the purlins 16. When an overhead lifting attachment is used, a modular spreader beam frame may be utilised to evenly distribute the load on the pod 10, as well as to minimise the vertical lift height required from the telehandler telescopic arm. The necessary wiring and electrical connections are then made, following which the structure is ready for commissioning.

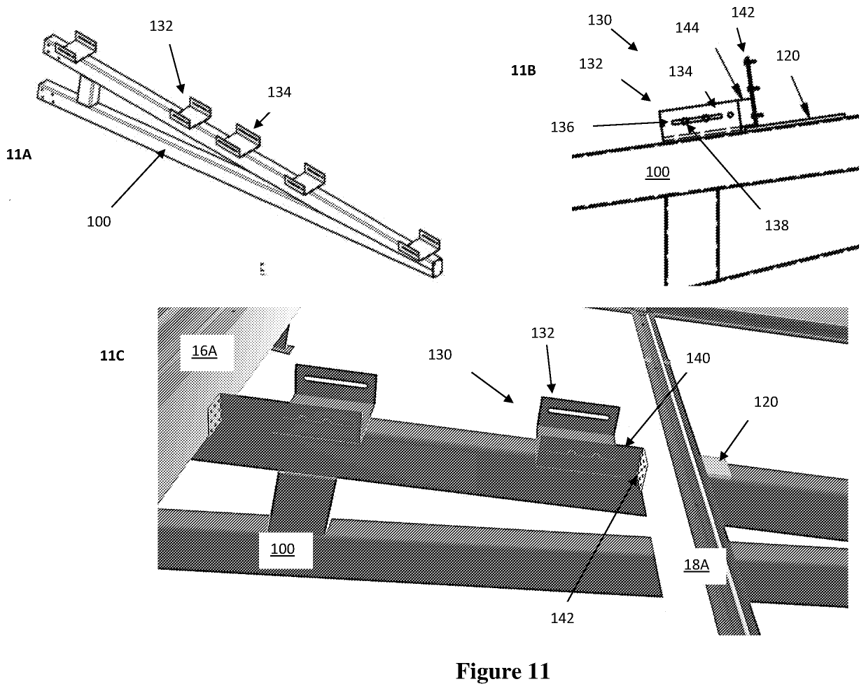

Referring now to FIG. 11, shown is an adjustable cleat system for use with the uprights 100. During installation, it may be challenging to accurately position the pods 10 on top of the uprights 100, 100. In order to further simplify this operation, and to remove the need for a high degree of precision, a plastic plate 120 may be provided on the upright's upper surface. Plate 120 may be affixed to the upright 100 using any suitable means (e.g, with an adhesive), and is located upwardly of the cleat 130 that the pod's edge is configured to abut. Plate 120 has a lower coefficient of friction than the upright 100 itself, and enables the longitudinal purloins 16A, 16A and rafter 18A (and particularly the lowermost purloin 16A which, due to the angle of the pod 10, experiences a greater proportion of its weight) to be more easily slid along upright 100 into its final position.

Cleat 130 includes a U-shaped bracket 132 that is configured to be mounted to the upright 100 at a predefined position using any suitable means (e.g. using fasteners such as nuts and bolts, or by welding). Upstanding sides 134, 134 of cleat 130 include channels 136 configured to slidably receive fasteners 138, 138 therethrough. Cleat 130 also includes a sliding member 140, having an abutting portion 142 which is configured to abut the edge of the pod 10 and a sliding portion 144 configured to slide against one of the upstanding sides 134, and be fastenable thereto upon tightening of fasteners 138, 138.

In this manner, the pod 10 can be set down upon spaced apart uprights 100, 100, and then slid into position using the reduced frictional properties of the plates 120, 120 positioned appropriately on a respective upright. The abutting portions 142, 142 of the cleats 130, 130 may then be advanced into an abutting position against the pod's side (i.e. the “downhill” side of purloin 16A or rafter 18A). The cleat 130 is then fastened to the pod 10 (and hence the pod 10 attached to the upright 100) by attaching the abutting portion 142 to the pod and by tightening the fasteners 138, 138, whereupon the components are fixed with respect to each other.

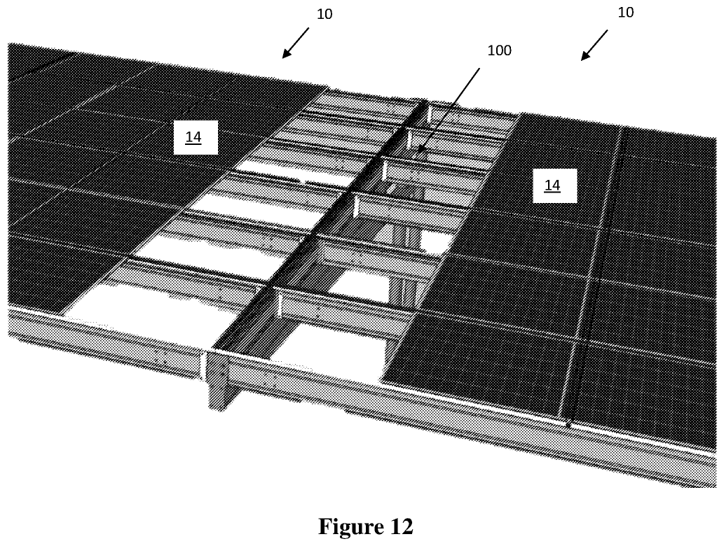

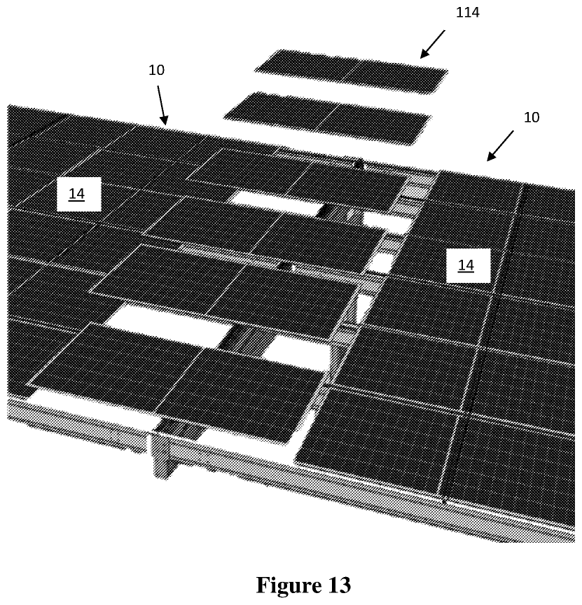

In some circumstances, and as is depicted in FIGS. 12 and 13, the length of the solar panels 14 will not evenly divide into the length of the pods 10 (i.e. a 2 m long panel will not evenly divide into a 7.5 m long pod). In such circumstances therefore, once all the pods 10 have been installed on the uprights 100, additional solar panels that span between two adjacent pods 10, 10 are installed. In the embodiment shown, six additional panels 114 which span 1.5 m on one of the pods and 0.5 m on the next pod will be installed once the two adjacent pods have been installed as described above.

It will be appreciated that the present invention provides a number of new and useful advantages. For example, specific embodiments of the present invention may provide one or more of the following advantages:
the roof structure's modular nature drastically reduces the amount of time to install a shade structure and correspondingly the associated labour cost;
the roof structure is easily transportable and is substantially waterproof;
the roof structure's modular nature enables its pre-assembly under factory conditions, which are highly automated, predictable to cost and have a much higher efficiency than in-situ installation in site conditions (the inventor estimates that roughly 80% of the installation works can be completed in the factory);
automated laser cutting and robotic welding can be used in the manufacture of the structure, which results high dimensional accuracy and repeatability;
automated laser cutting and robotic welding can be used in the manufacture of the structure, which allows for many elements to be mass produced at a low cost and improves material yield by facilitating mechanically advantageous designs that would ordinarily be too intensive to cost effectively produce; and
the fabricated beams may be hollow section, enabling cable to be internally reticulated and eliminate visible screw lines.

It will be understood to persons skilled in the art of the invention that many modifications may be made without departing from the spirit and scope of the invention. All such modifications are intended to fall within the scope of the following claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that any prior art publication referred to herein does not constitute an admission that the publication forms part of the common general knowledge in the art.

1. A modular roof structure comprising a frame to which an array of solar panels are attachable, the frame comprising:
purlins at a periphery of the roof structure, the purlins being configured to receive edges of the solar panels thereat; and
rafters arranged between the purlins in a configuration to receive opposing edges of adjacent solar panels thereat, the rafters comprising gutters for collecting water that runs off the solar panels and directing the collected water to a water outlet.

2. (canceled)

3. The modular roof structure of claim 1, wherein the rafters are laterally and longitudinally arranged with respect to the purlins to correspond with a size of the solar panels.

4. The modular roof structure of claim 3, wherein lateral gutters are vertically spaced from longitudinal gutters, whereby the collected water flows from one into the other.

5. The modular roof structure of claim 1, wherein the collected water is directed by the gutters to a common water outlet.

6. The modular roof structure of claim 1, wherein the solar panels are attached to the frame via attachments that are accessible from underneath the frame.

7. The modular roof structure of claim 1, wherein the gutters comprise outwardly extending flanges at an upper portion thereof.

8. The modular roof structure of claim 7, wherein the flanges comprise attachments for the solar panels.

9. The modular roof structure of claim 8, wherein the attachments comprise apertures that are alignable with apertures in the undersides of frames of the solar panels, and through which a fastener is receivable.

10. The modular roof structure of claim 1, wherein the rafters are closed section beams.

11. The modular roof structure of claim 10, wherein electrical wiring is locatable within voids inside the rafters.

12. The modular roof structure of claim 1, wherein the purlins define the entire periphery of the roof structure.

13. The modular roof structure of claim 1, wherein the purlins are closed section beams.

14. The modular roof structure of claim 13, wherein electrical wiring is locatable within voids inside the purlins.

15. The modular roof structure of claim 1, wherein the roof structure is rectangular in shape.

16. The modular roof structure of claim 1, wherein the array is two solar panels wide and four solar panels long.

17. The modular roof structure of claim 1, further comprising guttering on at least the lowermost, in use, purlin.

18. A method for constructing a structure in which an array of solar panels define an upper surface thereof, the method comprising:
affixing one or more upright supports to the ground;
positioning one or more of the modular roof structures of claim 1 on top of the one or more upright supports; and
attaching the one or more modular roof structures to the one or more upright supports.

19. The method of claim 18, further comprising electrically connecting the solar panels to an electricity grid.

20. The method of claim 18, wherein the structure is a carport, a COLA, a glass house, or a shed.
